(19) United States
(12) Patent Application Publication
(10) Pub. No.: US 2006/0194033 A1
(43) Pub. Date: Aug. 31, 2006

(54) Laminate material

(75) Inventors: Kerry Emmett Arthur Kirwan, Coventry (GB); Gordon Frederick Smith, Warwickshire (GB)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: University of Warwick, Warwickshire (GB)

(21) Appl. No.: 10/552,726

(22) PCT Filed: Apr. 8, 2004
(86) PCT No.: PCT/GB04/01560

§ 371 Date: Mar. 30, 2006

(30) Foreign Application Priority Data
Apr. 8, 2003 (GB) 0308028.0

(51) Int. Cl. B32B 27/30; B32B 27/00

(52) U.S. Cl. 428/220; 428/411.1; 428/522; 156/308.2

(57) ABSTRACT

A laminate material comprising two components, a first thermoplastic polymer substrate and a second thermoplastic polymer blown film; wherein the film and substrate are directly bonded one to another and where substantially one face or side of the substrate only is laminated with film; such that in use the resistance of the substrate to a localised impact on a non-laminated face is significantly reduced by the presence of the film layer.

This invention relates to a laminate material made from thermoplastic polymers the impact strength of which depends upon the direction of impact; and to a method of making such a material.

Thermoplastic polymer materials are widely used in manufactured goods. Some such materials; such as polycarbonates are very tough and are used extensively in the manufacturing industries. For example; polycarbonates are used for glazing applications where they have been found to provide excellent intruder resistance. However, in such applications the use of such a tough material hinders escape in an emergency; for example, from a crashed vehicle. There is therefore a need for materials that exhibit directional impact properties; that is varying strength on each face; for example, in sheet form such a material may be broken more easily by impacting the inner face than by impacting the outer face. Thus, vehicle glazing made of such a material could be relatively easy to break from the inside while retaining its normal strength in respect to outside impacts.

It is an object of this invention to provide a laminate thermoplastic polymer material with directional impact properties. It is a further object to provide a method for manufacturing such a material where the degree of weakness on a selected face can be controlled by appropriate selection of manufacturing process conditions.

In one aspect the invention is a laminate material comprising two components, a first thermoplastic polymer substrate and a second thermoplastic polymer film; wherein the film and substrate are directly bonded one to another and where substantially one face or side only of the substrate is laminated with film; and the film has many small flaws generated as a result of the manufacturing process such that in use the resistance of the substrate to a localised impact on a non-laminated face is significantly reduced by the presence of the flaws in the film layer.

In another aspect the invention is a laminate material comprising two components, a first thermoplastic polymer substrate and a second thermoplastic polymer blown film; wherein the film and substrate are directly bonded one to another and where substantially one face or side of the substrate only is laminated with film; such that in use the resistance of the substrate to a localised impact on a non-laminated face is significantly reduced by the presence of the film layer. Preferably the polymer blown film is impact modified.

In a further aspect the invention comprises a method of making the above laminate material where thermal bonding is used to directly bond a first thermoplastic polymer substrate and a second thermoplastic impact modified polymer blown film. Preferably, the directional impact properties of the material are controlled by adjusting the strength of the thermal bonding. The temperature and/or pressure applied to bond the film and substrate may be varied in order to adjust the strength of the thermal bonding, Preferably, the thermoplastic polymer substrate is a polycarbonate material and the thermoplastic impact modified polymer blown film is a highly rubberised blown acrylic film. The thickness of the blown film may be between 50 and 250 μm and is preferably about 100 μm.

Typically, the material may be manufactured in sheet form. However, the invention may also be used where the material is shaped and has varying thickness; for example a vehicle windscreen. The material of the invention may optionally have added weathering materials or colouring agents.

The material of the invention has many advantageous safety applications; for example, glazing windows and partitions in vehicles and also domestic/commercial applications such as glazing in windows or showers enclosures in the home; where escape in an emergency is an important issue.

The invention will now be described by reference to the following figures;

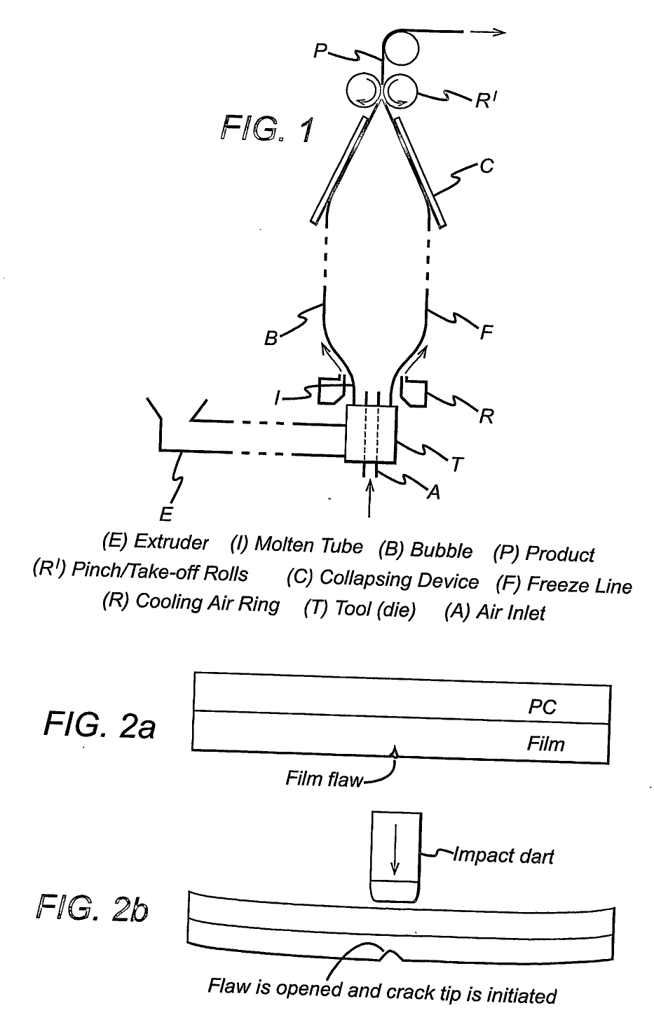

FIG. 1 shows schematically the main features of known apparatus used for manufacturing blown film;

FIGS. 2a and 2b show schematically a laminated sheet according to the invention before and during a localised impact; and

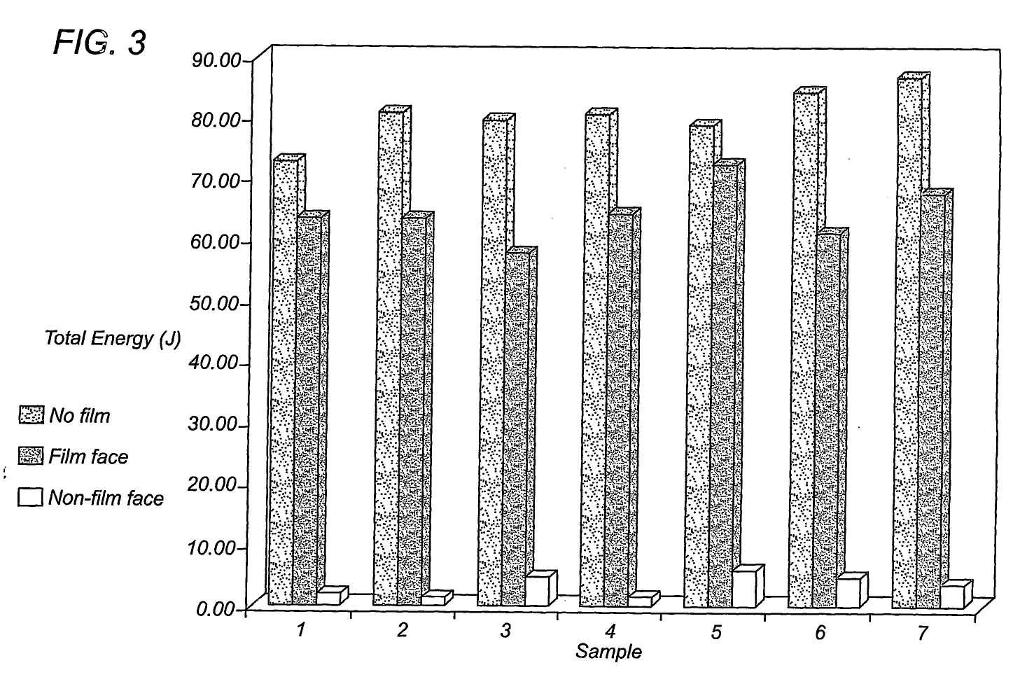

FIG. 3 is a bar chart that shows the impact resistance of unlaminated polycarbonate sheet material, and laminated polycarbonate sheet material (from both sides) prepared according to the method of the invention described in Example 1.

In order to achieve the desired directional impact properties it has been found that it is much preferred to use a blown film/layer. However, a layer produced by other means such as simple extrusion may also be used provided that many small surface flaws are present. Preferably, blown film is impact modified; that is it has been toughened, typically by adding rubberising agents. In the film blowing process (see FIG. 1) plastic melt passes through an extruder (E) and a die (T)—that forms it into an annular shape, usually directed upwardly. A molten plastic tube emerges from the die and this is subjected to both a moderate internal air pressure generated by process air introduced via an air inlet (A), and a longitudinal force via take-off rolls (R′). The tube is cooled by air from an external air ring (R). Under these conditions the molten tube gradually expands into a larger diameter stable solid cylindrical “bubble” beyond the ‘freeze’ line (F). The bubble is gradually flattened in a collapsing device (C), which consists of a pair of converging, ladder-like sets of idler rolls, and thereafter by the take-off rolls (R′) where it is handled as a thin flat film.

It has been found that blown film has many small flaws in its surface. These flaws play a vital role in achieving the object of the invention. When the non-laminated side of a material laminated according to the invention suffers a localised impact of sufficient intensity the surface of the film is put into tension (see FIGS. 2a and 2b) upon impact and flaws present in surface of the blown film, especially in the locality of the impact, will open to form a crack. A crack may be initiated at a very low energy level and the crack will then propogate backwardly first through the film and then to through the directly bonded substrate, with relative ease.

In simple terms, the blown film ‘tears’ easily in tension and the crack then propagates rapidly through the sample, causing brittle failure. This effect is most pronounced for localised impacts (as produced by sharp objects). If the impact is from a blunt object it will normally be spread over a larger area, and failure will not occur so readily. This property is particularly advantageous for glazing applications, where a single blow by a key/stilleto heel/hammer is likely to induce failure, but a blow from an elbow or head would not. Thus, safety would not be compromised during an accident, but escape would be assisted after an accident.

It has been found most advantageous to employ an impact modified material for the blown film; typically a highly rubberised acrylic blown film. During a low energy level impact on the film face, the surface of the highly rubberised film is put into a compressive state by the impacting object and any flaws are effectively closed. A crack in the blown film is not initiated until a medium-to-high energy level is reached due to the cushioning effect of the compressed rubber molecules. The use of an impact modified blown film material, rather than simply a blown film material, advantageously results in the impact strength of the film face up side of the material being only marginally less than substrate alone (un-laminated material).

For a crack to progress through a medium it has to have sufficient energy at the crack tip to propagate. There must also be a continuing medium for the crack to travel through, i.e. good adhesion at the interface. If there is not good adhesion at the interface then delamination may occur; the crack tip is blunted and cannot continue through the sample. This phenomenon is known as ‘film-debonding’ and is caused by low interface toughness compared to that of the film and the substrate.

The following Examples detail methods for producing a sheet of material according to the invention. While in Examples 1 and 2 injection moulding was used to thermally bond the substrate and the blown film it has been found that other laminating process can be used such as co-extrusion, calendering etc.

### EXAMPLE 1

Seven samples were manufactured using conventional injection moulding. A ‘blown’ impact modified rubberised acrylic film was laid in a mould cavity, comprising a simple flat plaque, measuring 150 mm×150 mm×3 mm, with a conventional runner and gate system. The film used was 100 μm thickness and was supplied by Polymer Extruded Products, 297 Ferry Street, Newark, N.J. 07105.

Molten Polycarbonate was back-injected onto the film. The polycarbonate grade was Bayer Makrolon AL2647 (supplied by Bayer GmbH, Germany). The process settings (see Table 1) were such that full mould fill and packing were obtained.

Finally, the samples were removed from the machine, the sprue and gates removed and then impact tested.

TABLE 1
Process Data

Barrel Temperatures: 260° C. to 280° C.
Injection Temperature: 280° C.
Tool Temperature: 30° C.
Metering:- 92 mm
Screw Speed:- 100 rpm
Back Pressure:- 5 bar
Injection Speed:- 35 mm/s
Injection Pressure:- 175 bar
Changeover:- 5 mm
Holding Time:- 15 s
Holding Pressure:- 30 bar

Testing of Samples produced by Example 1

The samples produced via the method above were impact tested in two ways, the first with the film face up (i.e. film on the impact side) and secondly with the film face down (i.e. film opposite the impact face).

The impact tests used a Pneumatic Dart Impact machine equipped that complies with ASTM D3763-99 and a 12.5 mm radius hemispherical impact dart was used. The flat samples were placed in the clamp zone of the Dart Impact machine. When the safety door shuts the test pieces are hydraulically clamped in position. When the test is initiated the dart is fired downwards through the sample. The trials were conducted in accordance with ASTM D3763-99.

Three sets of samples were tested (see Table 1). Samples 1 to 7 relate to polycarbonate with no blown film laminate; Samples 8 to 14 relate to samples laminated according to the invention impacted upon the film face; and Samples 15 to 21 refers to samples laminated according to the invention an impact tested on the non-film face. The samples were impacted using an initial dart height of 40 mm and an impact velocity of 4 ms⁻¹. A computer logged data for post-test analysis. For these data the total energy absorbed by the component before failure along with observations of the manner of failure, i.e. brittle or ductile was logged. Impact tests were also conducted with unlaminated polycarbonate in order to provide a reference. The results are illustrated in FIG. 3.

It can be seen that the blown film face up samples exhibited impact failure energy levels (58 Joules to 73 Joules) only slightly less than for un-laminated polycarbonate samples (73 Joules to 87 Joules) of similar dimension; both failing in a ductile manner. However, a significantly lower energy of 1.7 Joules to 6.1 Joules was required when the sample was impacted on the polycarbonate face side (film face down) and the samples failed in a brittle manner.

Similar experiments have also been undertaken with another commercial grade acrylic; Oroglas DRT™ (available from Atofina—UK Head Office, Globe House, Bayley Street, Stalybridge, Cheshire SK15 1PY, United Kingdom)

It is believed that when a sample is impacted upon the film face, the film is placed into compression and any flaws effectively close and so do not initiate cracks and so the toughness and ductility of the polycarbonate is maintained.

TABLE 1
Impact Strength Test Data

| Sample | | Peak Load | Failure | Total Energy |
|---|---|---|---|---|
| Number | Impacted Upon | (N) | Mechanism | Absorbed (J) |
| 1 | No Film | 6519 | Ductile | 72.91 |
| 2 | No Film | 6860 | Ductile | 80.90 |
| 3 | No Film | 6875 | Ductile | 79.96 |
| 4 | No Film | 6947 | Ductile | 80.80 |
| 5 | No Film | 6926 | Ductile | 78.88 |
| 6 | No Film | 6675 | Ductile | 84.41 |
| 7 | No Film | 6800 | Ductile | 86.71 |
| 8 | Film Face | 6436 | Ductile | 63.57 |
| 9 | Film Face | 6403 | Ductile | 63.81 |
| 10 | Film Face | 6155 | Ductile | 57.89 |
| 11 | Film Face | 5616 | Ductile | 64.33 |
| 12 | Film Face | 6493 | Ductile | 72.50 |
| 13 | Film Face | 6070 | Ductile | 61.23 |
| 14 | Film Face | 6319 | Ductile | 67.66 |
| 15 | Non Film Face | 1048 | Brittle | 2.17 |
| 16 | Non Film Face | 663 | Brittle | 1.68 |
| 17 | Non Film Face | 1163 | Brittle | 4.89 |
| 18 | Non Film Face | 688 | Brittle | 1.78 |
| 19 | Non Film Face | 1433 | Brittle | 6.08 |
| 20 | Non Film Face | 998 | Brittle | 5.01 |
| 21 | Non Film Face | 904 | Brittle | 3.71 |

### EXAMPLE 2

By lowering the processing temperature of the polycarbonate material used for the substrate from 280° C. to 260° C. was found that it was possible to produce some samples that exhibited higher non film side impact strength than those discussed above, but still significantly lower than unlaminated polycarbonate components (see Table 2).

Closer inspection of the test pieces after impact testing revealed different failure characteristics. Firstly when impacted on the polycarbonate side samples failed in a ductile manner, similar to when the samples of Example 1 were impacted on the film side, and in contrast to the dramatic brittle ‘explosion’ failure observed for polycarbonate side tests undertaken (Example 1). Secondly, film in the area of the impact was severely stressed and de-laminated from the PC substrate in small pieces.

Thus, the level of energy required to induce failure can be increased or decreased by controlling the level of adhesion (direct bonding) between the film and the substrate; effectively using the film-substrate interface as a crack inhibitor. High interfacial adhesion means that the crack is able to propagate easily across the interface ; while low interfacial adhesion means that the crack has difficulty in crossing the interface as the film debonds from the substrate.

The interfacial strength of the thermal bond between the substrate and the blown film may be controlled by varying other process conditions such as injection temp, injection speed, holding pressure etc.

TABLE 2

| | | | Total Energy |
|---|---|---|---|
| Sample Number | Impacted Upon | Peak Load (N) | Absorbed (J) |
| 1 | Non-Film Face | 5627 | 42.06 |
| 2 | Non-Film Face | 5709 | 43.17 |
| 3 | Non-Film Face | 5490 | 41.24 |
| 4 | Non-Film Face | 5567 | 41.78 |
| 5 | Non-Film Face | 5740 | 43.30 |
| 6 | Non-Film Face | 5612 | 41.98 |
| 7 | Non-Film Face | 5730 | 43.22 |

1-13. (canceled)

14. A laminate material comprising two components, a first thermoplastic polymer substrate and a second thermoplastic polymer film; wherein the film and substrate are directly bonded one to another and where substantially one face or side only of the substrate is laminated with film; and the film has many small flaws generated as a result of the manufacturing process, such that in use the resistance of the substrate to a localized impact on a non-laminated face is significantly reduced by the presence of the flaws in the film layer.

15. A laminate material comprising two components, a first thermoplastic polymer substrate and a second thermoplastic polymer blown film; wherein the film and substrate are directly bonded one to another and where substantially one face or side of the substrate only is laminated with film; such that in use the resistance of the substrate to a localized impact on a non-laminated face is significantly reduced by the presence of the film layer.

16. A laminate material according to claim 14 wherein the polymer blown film is impact modified.

17. A method of making a material according to claim 14 where thermal bonding is used to directly bond the film and substrate.

18. A method according to claim 17 wherein the directional impact properties of the material are controlled by adjusting the strength of the thermal bonding.

19. A method according to claim 18 wherein the temperature and/or pressure applied to bond the film and substrate are varied in order to adjust the strength of the thermal bonding.

20. A method according to claim 17 wherein the thermoplastic polymer substrate is a polycarbonate material.

21. A method according to claim 17 wherein the film is a blown acrylic film.

22. A method according to claim 17 wherein the film is between 50 and 250 μm thickness.

23. A method according to claim 17 wherein the film is between 75 and 125 μm thickness.

24. A material made according to the method of claim 17.

25. A material according to claim 14 wherein the material is in the form of a sheet.

26. A laminate material comprising two components, a first layer and a second thermoplastic polymer layer, bonded to one another; the second layer having a lower resistance to a localized impact than the first layer, prior to bonding; but wherein an impact against the face of the first layer of the laminate enables breakage of the laminate material with a lower impact energy than that required to enable breakage of said first layer prior to bonding.
